(19) United States
(12) Patent Application Publication
(10) Pub. No.: US 2004/0044539 A1
(43) Pub. Date: Mar. 4, 2004

(54) Computer system, program and method for the mapping of data between a centralized database and a visual graphical interface to allow multiple computers to communicate across a standard platform

(76) Inventors: Todd Taricco, Zephyr Cove, NV (US); Ludwig C. Zelt, Rancho Palos Verdes, CA (US)

Correspondence Address: IRELL & MANELLA LLP, 840 NEWPORT CENTER DRIVE, SUITE 400, NEWPORT BEACH, CA, 92660, US

(21) Appl. No.: 10/232,073

(22) Filed: Aug. 30, 2002

(51) Int. Cl. G06F 17/60

(52) U.S. Cl. 705/1; 705/402; 705/26

(57) ABSTRACT

A method and system for transacting business over an electronic communication network. The method includes generating a request and a response for a business transaction over the communication network from a buyer computer and a seller computer, respectively. A third party computer receives the request and response and generates a separate transaction to obtain transportation, insurance and/or a warranty for goods associated with the request. The third party computer can select the transportation, insurance and/or warranty from a plurality of bids transmitted through the communication network. The third party can receive payment from the selected transportation, insurance and/or warranty entity. The system also maps data of a data file to user specified data fields generated at a graphical user interface (GUI). The specified fields are correlated with predefined fields of the data file. This allows the end user to customize their GUI. The system can also map data without dumping an entire data file.

### BACKGROUND OF THE INVENTION

1. Field of the Invention

The subject matter disclosed generally relates to a method and system for transacting business through an electronic communication network.

2. Background Information

There have been developed a number of software programs, websites, etc. that allow a buyer to purchase goods through a wide area electronic communication network. For example, there are business entities that operate websites that allow consumers to purchase books, flowers and other goods “on-line”. On-line transactions generally include the steps of logging onto a website, filling in a number of fields on graphical user interfaces (GUIs) provided by the website. The on-line order is then transmitted to a warehouse, manufacturer or other entity that can produce and/or ship the selected item(s) to the consumer.

The means and cost for transporting and insuring an item ordered on-line is selected by the operator of the website or the entity that ships the product. Shipping and insurance cost can be quite significant particularly if the transaction is between business entities (eg. B2B business transaction). For example, shipping bulk steal or other such items may result in a significant freight charge.

Business entities typically contain different software platforms and software application programs for initiating, completing and tracking business transactions. The existence of different programs make it difficult to create an efficient and fluid on-line B2B network. One approach is to have every entity use the same software program with a predefined set of data fields that can be filled in by the users. The difficulty arises in getting all of the entities to agree on the number and title of the fields. Additionally, the data may be stored in different data formats.

U.S. Pat. No. 6,154,748 issued to Gupta et al. and assigned to International Business Machines Corp. (“IBM”) discloses a system that maps data from a data file to certain data fields specified by an end user. As described in the IBM patent the system presents a GUI with a two-dimensional mapping matrix that lists the existing fields of a dump data file and field names created by an end user. The end user then selects appropriate boxes in the mapping matrix to correlate the existing data fields with the user specified fields. A mapping section then maps the data of the data file with the fields specified by the user. The newly generated data file is then stored for future use.

The mapping section typically maps data from a “dumped” data file. The relevant data is then parsed from the file. Dumping an entire data file is an inefficient means of mapping data. Large portions of the data file may not even be used in the newly generated data file. Dumping the entire file creates additional processing overhead and may result in bandwidth issues if the data is transmitted over a communication network.

### BRIEF SUMMARY OF THE INVENTION

A method and system for transacting business over an electronic communication network. The method includes generating a request to initiate a business transaction and responding to the request. Both the request and the response are transmitted over the electronic communication network. The request and response are received by a third party computer which facilitates a separate transaction to transport, insure and/or obtain a warranty for goods associated with the business transaction. The separate transaction occurs over the electronic communication network.

### BRIEF DESCRIPTION OF THE DRAWINGS

FIGS. 1 is a schematic of a network system that can be used to conduct a business transaction through an electronic communication network;

FIG. 2 is a schematic of a computer of the system;

FIG. 3 is a flowchart showing a business transaction conducted through the system;

FIG. 4 is an illustration of a graphical user interface screen;

FIG. 5 is an illustration of a graphical user interface screen;

FIG. 6 is an illustration of a graphical user interface screen;

FIG. 7 is an illustration of a graphical user interface screen;

FIG. 8 is an illustration of a graphical user interface screen;

FIG. 9 is an illustration of a graphical user interface screen.

### DETAILED DESCRIPTION

Disclosed is a method and system for transacting business over an electronic communication network. The method includes generating a request and a response for a business transaction over the communication network from a buyer computer and a seller computer, respectively. A third party computer receives the request and response and generates a separate transaction to obtain transportation, insurance and/or a warranty for goods associated with the request. The third party computer can select the transportation, insurance and/or warranty from a plurality of bids transmitted through the communication network. The third party can receive payment from the selected transportation, insurance and/or warranty entity. The system also maps data of a data file to user specified data fields generated at a graphical user interface (GUI). The specified fields are correlated with predefined fields of the data file. This allows the end user to customize the GUI. The system can also map data without dumping an entire data file.

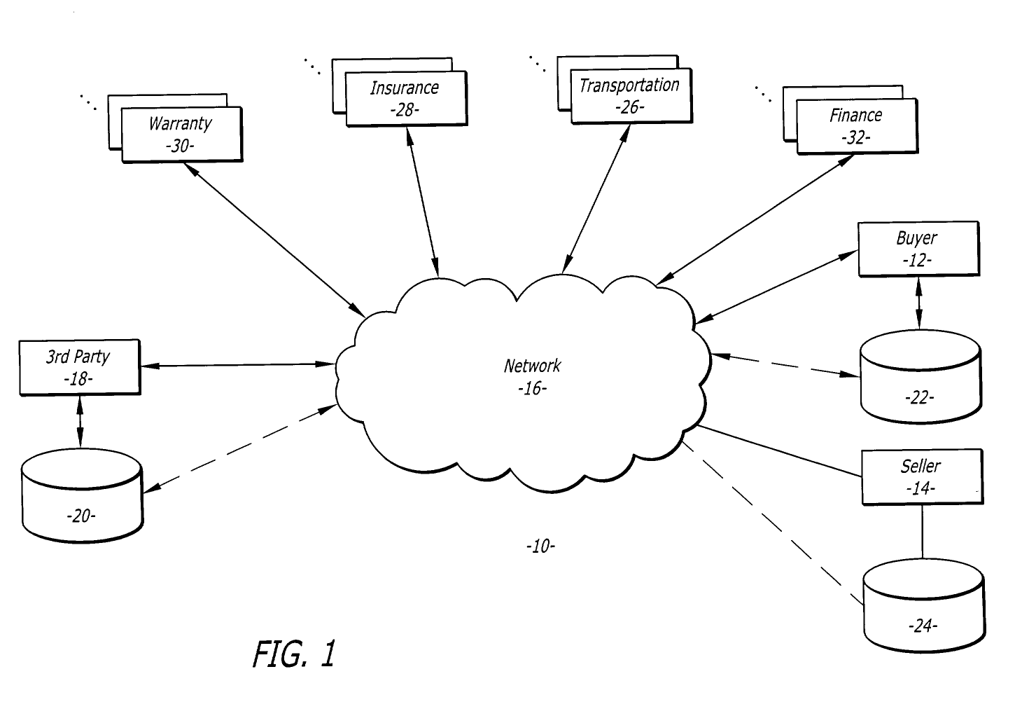

Referring to the drawings more particularly by reference numbers, FIG. 1 shows a system 10 that can be used to conduct an electronic business transaction. The system 10 includes a buyer computer 12 and a seller computer 14 that are connected to an electronic communication network 16. The electronic communication network 16 may be a wide area network (WAN) such as the internet. Accordingly, communication may be transmitted through the network 16 in TCP/IP format. Although a WAN is described, it is to be understood that the network 16 may be a metropolitan area network (MAN), or a local area network (LAN). Additionally, although the internet is described, it is to be understood that the network 16 may be a WAN system that operates in a protocol other than TCP/IP.

The system 10 also includes a third party computer 18. The third party computer 18 may be connected to a third party server 20. Both the computer 18 and the server 20 may be connected to the network 16. The server 20 may contain one or more data files. Likewise, the buyer computer 12 may be connected to a buyer server 22 and the seller computer 14 may be connected to a seller server 24. The servers 22 and 24 may also be connected to the network 16. Although the servers are shown separate from the computers, it is to be understood that the servers and computers for the buyer, seller and third party may be combined into one system.

The system 10 may include one or more transportation computers 26, one or more insurance computers 28, one or more warranty computers 30 and/or one or more finance computers 32. Computers 26, 28, 30 and 32 are connected to the network 16. Each transportation computer 26 may be operated by a separate transportation entity. Likewise, separate entities may operate the insurance 28, warranty 30 and finance 32 computers.

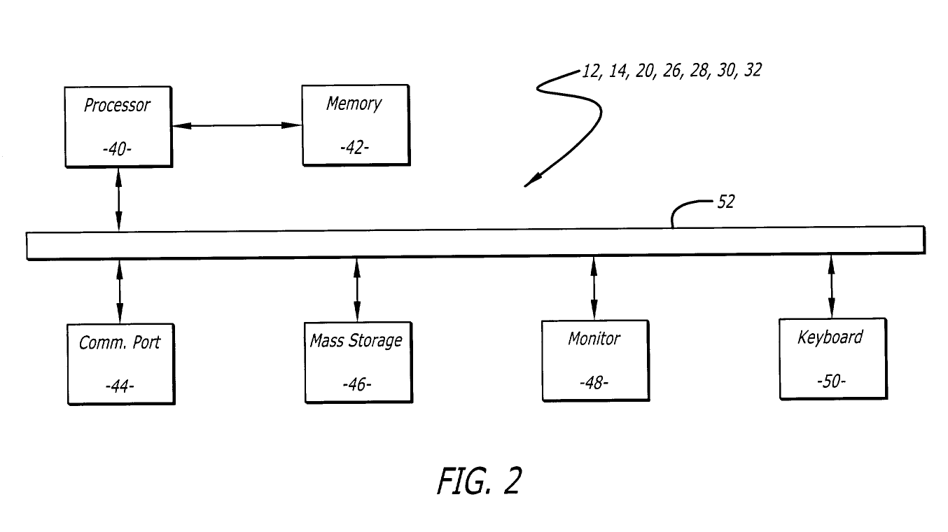

FIG. 2 shows an embodiment of a computer 12, 14, 20, 26, 28, 30 and/or 32. The computer includes a processor 40 connected to one or more memory devices 42. The memory device 42 may include both volatile and non-volatile memory such as read only memory (ROM) or random access memory (RAM). The processor 40 is capable of operating software programs in accordance with instructions and data stored within the memory device 42.

The processor 40 may be coupled to a communication port 44, a mass storage device 46, a monitor 48 and a keyboard 50 through a system bus 52. The communication port 44 may include an ETHERNET interface that allows data to be transmitted and received in TCP/IP format. The system bus 52 may be PCI or another conventional computer bus. The mass storage device 46 may include one or more disk drives such as magnetic or optical drives.

Without limiting the scope of the invention the term computer readable medium may include the memory device 42 and/or the mass storage device 46. The computer readable medium will contain software programs in binary form that can be read and interpreted by the computer. In addition to the memory device 42 and/or mass storage device 46, computer readable medium may also include a diskette, a compact disc, an integrated circuit, a cartridge, or even a remote communication of the software program. Although not shown, the servers 20, 22 and 24 may also have a processor 40, memory etc, as is known in the art.

The third party computer 20 and server 24 may in combination, or separately, contain a relational database that correlates data with individual data fields. The computer 20 and server 24 may either in combination, or separately, operate a relational database management system (RDBMS).

The RDBMS of the system 10 may include a website that can be accessed by the computers 12, 14, 26, 28, 30 and 32. The website may contain a number of graphical user interfaces that allow a buyer and a seller to conduct a business transaction through the network 16. The graphical user interfaces may include screens that allow the end user to customize the various fields of data. The GUIs may also allow a buyer to initiate a request to purchase goods through the computer 12 and a seller to respond to the request.

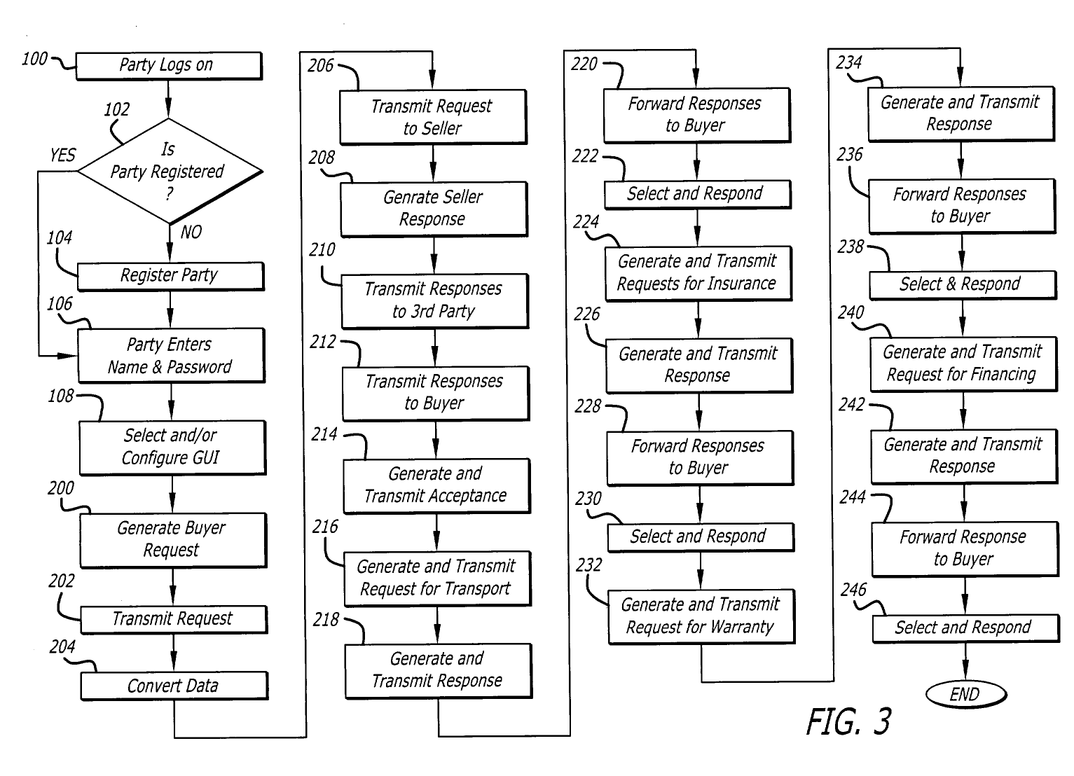

FIG. 3 shows a flowchart of a method for performing a business transaction across the network 16. In block 100 the buyer, seller, transportation entity, insurance entity, warranty entity and/or finance entity log onto the RDBMS website through the computers 12, 14, 26, 28, 30 and 32, respectively. For purposes of simplicity the buyer, seller, transportation entity, insurance entity, warranty entity and finance entity will also be referred to as a party. In decision block 102, it is determined whether the party logging onto the system is a registered participant. If the party is not registered then the process proceeds to block 104 where the party completes a registration form and transmits the form to the third party.

It being understood that the third party typically operates the third party computer 18, server 20 and RDBMS. The party obtains a valid user name and a password upon approval from the third party. The party may register as a buyer, a seller or a partner. For purposes of simplicity a partner will be a party that is not a buyer or a seller. For example, the transportation entity, insurance entity, warranty entity and finance entities are all considered partners.

Each party may establish a chain of command hierarchy for access to the system. For example, the hierarchy may include a master that can change any data and perform any transaction through the system. The hierarchy may include underling users that are limited in what data they can modify and what business they can transact. For example, an underling may be limited to buying or selling goods up to a maximum dollar limit. The registration may also include credit information, particularly for buyers. This credit information may be separately investigated and approved by the third party. The buyer may also enter supplier profile data. The supplier profile data may be updated by the buyer upon logging into the system.

In block 106, the party enters a user name and a password to enter the RDBMS. The party may also update its user profile. In block 108 the party selects and/or configures the GUI that will be used to conduct the business transaction. The party may use an existing GUI template provided by the RDBMS. The templates may be specific for a particular transaction and/or industry. Alternatively, the party may create its own customized interface GUI.

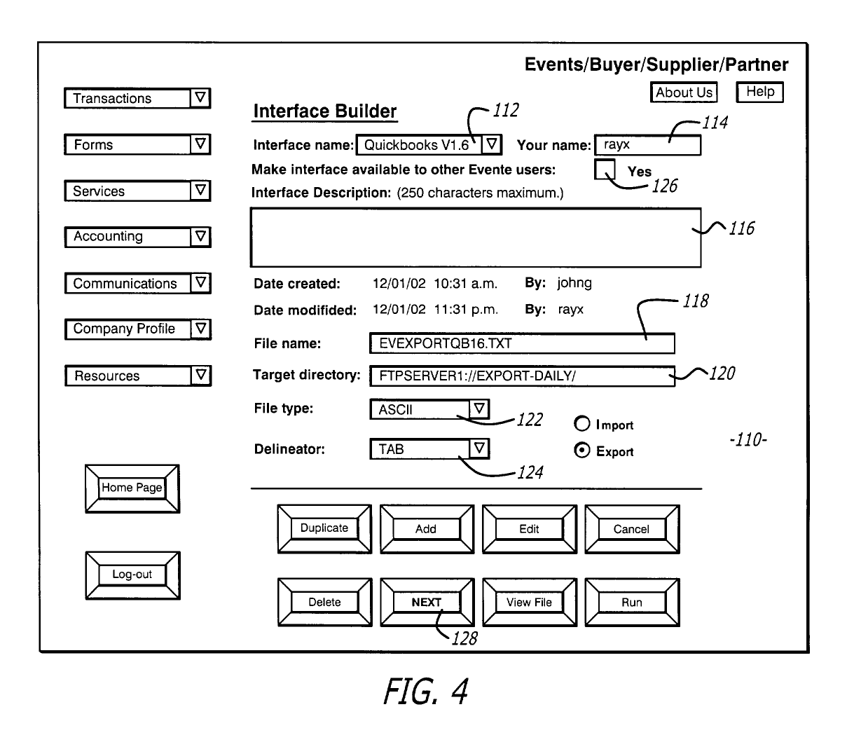

FIG. 4 shows a GUI 110 that allows a party to build an interface. The GUI 110 has various fields including an Interface Name 112, Your Name 114, Interface Description 116, File Name 118, Target Directory 120, File Type 122 and Delineator 124 fields. There is also a select box 126 that allows the interface created by the party to be used by another party. The party can select the NEXT button 128 to move to the next screen after the fields 112, 114, 116, 118, 120, 122 and 124 have been filled.

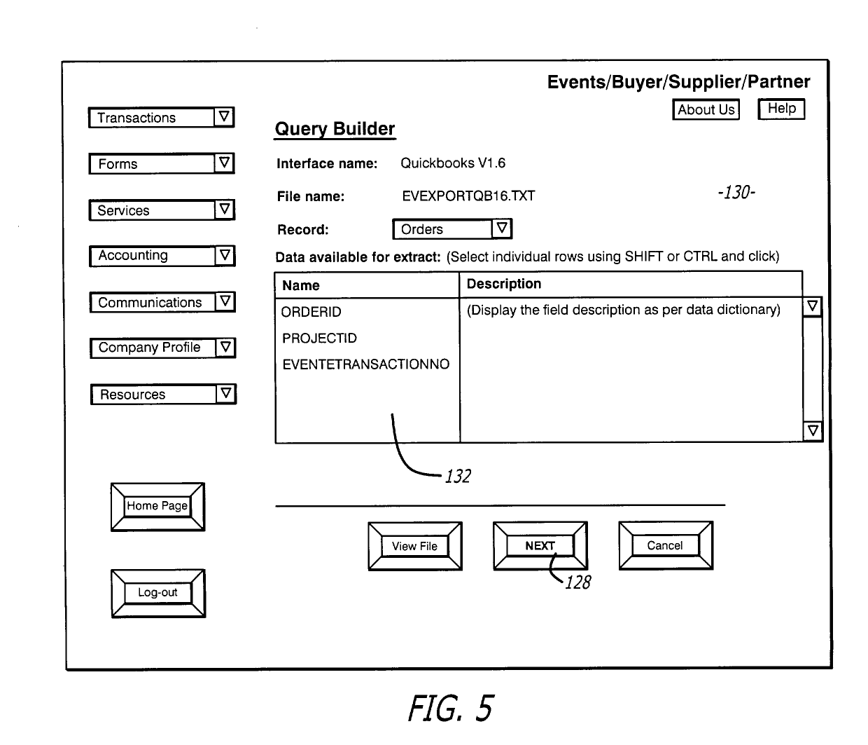

As shown in FIG. 5, the next screen 130 may include a table 132 that list various data that will be entered and/or viewed to conduct a transaction. The table 132 list a number of different predefined fields such as ORDERID, PROJECTID and EVENTETRANSACTIONNO along with a description of the data associated with these fields. The party can select one or more of the predefined fields for use in the GUI interface. The party can then move to the subsequent screen by selecting the NEXT button 128.

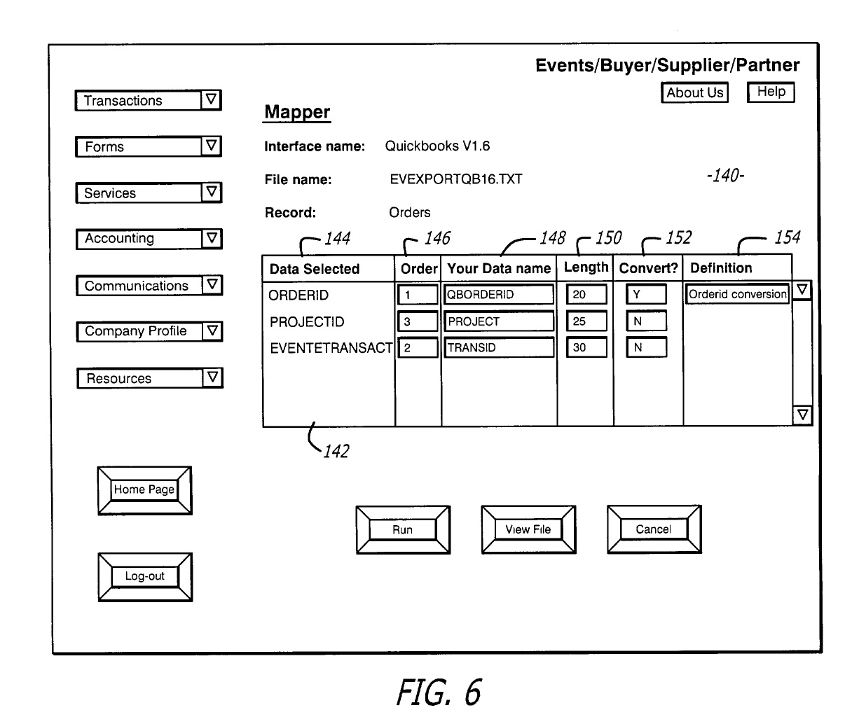

FIG. 6 shows a screen 140 with another table 142 that allows the party to correlate the predefined field to a party specified field name. The table 142 may include a column 144 that list the predefined field names, a column 146 for the order of the predefined field name, and a column 148 for the party user specified field name. The table 142 may also have a column 150 that defines the character length for each field, a column 152 that allows the user to select whether the data associated with the predefined field name must be converted, and a column 154 that defines the type of conversion.

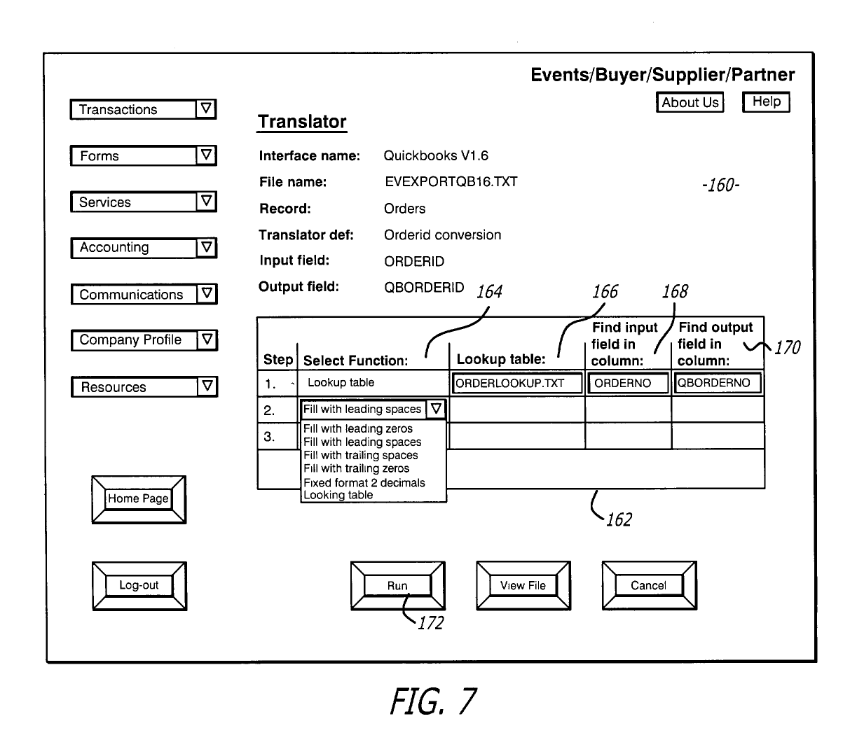

FIG. 7 shows a screen 160 that allows the party to select the type of conversion. The screen 160 includes a table 162 with a column 164 for selecting the conversion function. The conversion function may include adding zeros or spaces to existing data. Alternatively, the conversion may include a lookup table. Column 166 defines the file name for the lookup table. Columns 168 and 170 defined the corresponding predefined field names and party specified field names, respectively. After the GUI interface has been built the party may select the RUN button 172.

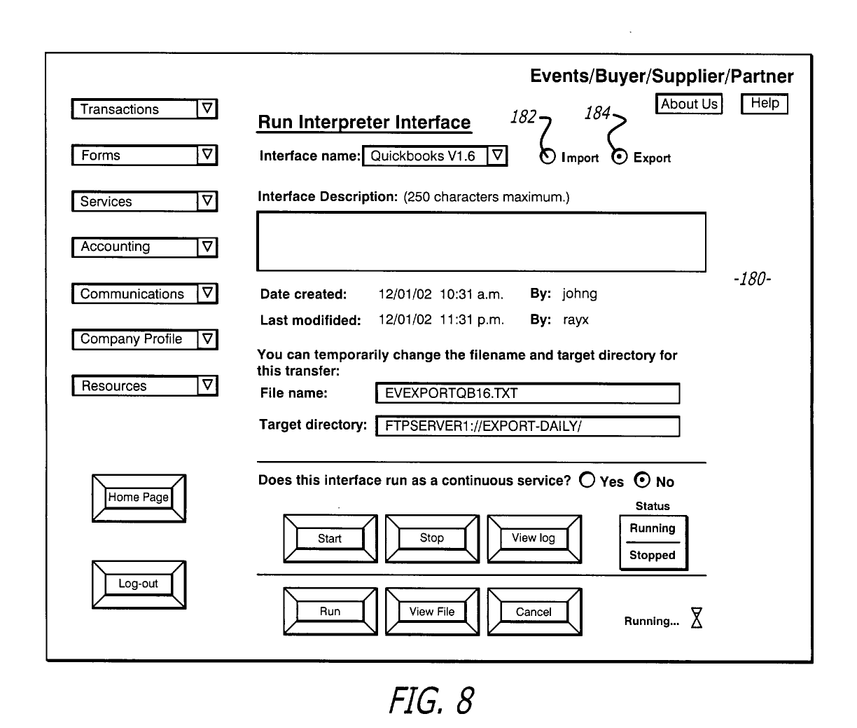

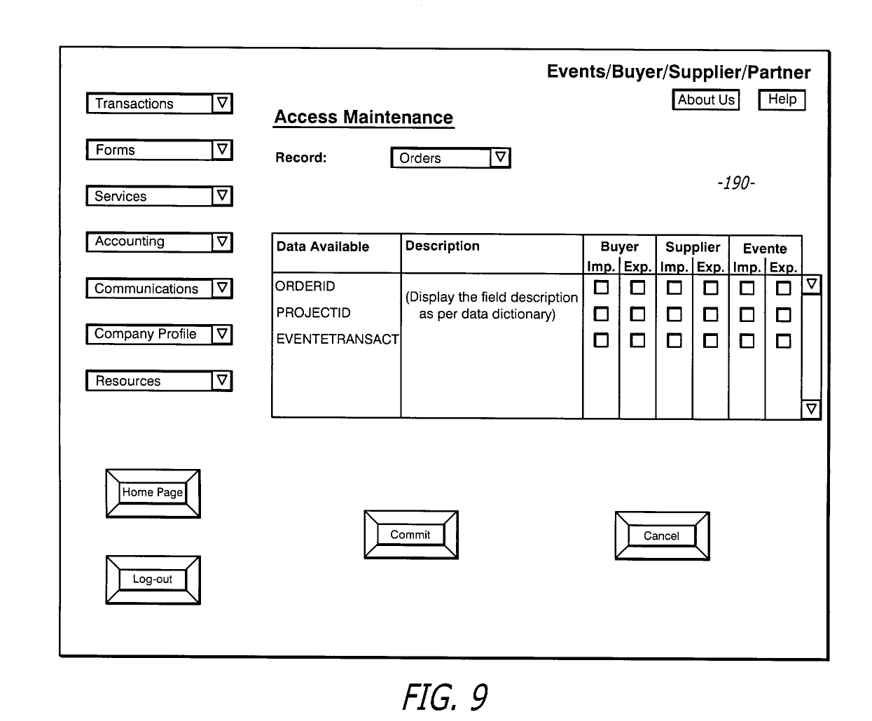

FIG. 8 shows a screen 180 displayed after the RUN button 172 has been selected. The screen 180 includes Import 182 and Export 184 buttons. FIG. 9 shows a screen 190 that allows the party to select whether the predefined field is an import or an export. An import typically pertains to a transfer of data into the system. For example, the buyer may import data relating to pricing, delivery, specifications of goods. An export relates to the extraction of data. For example, a seller may want to upload a request from a buyer.

If the file is an export then the RDBMS renders the appropriate data from memory and provides the data in the format specified by the party. If the field is an import then the process reads the predefined fields, party defined fields, order number and field length. If the conversion flag is checked then the process also converts data for the appropriate fields. The data can be converted by reading a lookup table. Alternatively, the data can be reformatted in accordance with the format function defined in column 164 of screen 160 shown in FIG. 7. The converted data is then stored in the server 20. The process allows a party to customize the GUI interface. Additionally, by selecting the specific conversion functions for each field the process can translate data from certain fields without having to dump an entire file.

Referring again to FIG. 3, the parties can conduct a business transaction after building the desired GUI interfaces. In block 200 a request to initiate a business transaction may be generated at the buyer computer. The request may be to purchase a quantity of goods. The data is entered with buyer specified field names. By way of example, the request could be a request for quote (RFQ), a request for purchase (RFP), or a purchase order (PO).

In block 202 the request is transmitted to the third party computer/server over the communication network. The third party computer/server may convert the data into the predefined field names of the buyer in block 204. In block 206 the third party computer transmits the request to registered seller computers. The transmission of the request may be in response to queries by the seller computers. The third party computer may convert the data to the predefined field names of the supplier before transmission to the sellers.

The third party computer may provide a list of sellers/suppliers that can be selected by the buyer. The request is then only transmitted to the selected sellers. Alternatively, the request may only be transmitted to sellers approved by the third party. As yet another alternative, the request may be transmitted to all sellers in an open bidding process.

The sellers may generate responses to the request in block 208. The responses may be transmitted to the third party computer in block 210. The third party computer may perform the appropriate data conversion and forward the responses to the buyer computer in block 212. The buyer computer can then generate and transmit an acceptance to one of the responses in block 214 that is forwarded to the selected seller(s)

The third party computer may compile a rating file that can be viewed by the various parties of the system. There may be separate rating listings for buyers, sellers, transportation entities, insurance entities, warranty entities and financiers.

In block 216 the third party computer can generate and transmit a request for transportation of the goods associated with the business transaction, to the transportation computers. The data can be mapped and converted into the appropriate party specified field names created by each individual transportation entity. The transportation computers can generate and transmit a response in block 218.

The responses can then be converted and forwarded to the buyer computer in block 220. The buyer may then select one of the transportation responses and return an acceptance in block 222. Alternatively, the third party may automatically select one of the transportation responses and return an acceptance message. With either method the selected transportation entity transfers a payment to the third party as a fee. The payment may be an electronic transfer from computer 26 to computer 18.

The third party computer may provide a list of transportation entities that can be selected by the buyer. The request is then only transmitted to the selected transportation entities. Alternatively, the request may only be transmitted to transportation entities approved by the third party. As yet another alternative, the request may be transmitted to all transportation entities in an open bidding process.

In block 224 the third party computer can generate and transmit a request for insurance on the goods being transported, to the insurance computers. The data can be mapped and converted into the appropriate party specified field names created by each individual insurance entity. The insurance computers can generate and transmit a response in block 226.

The responses can then be converted and forwarded to the buyer computer in block 228. The buyer may then select one of the insurance responses and return an acceptance in block 230 that is forwarded to the selected insurance computer. Alternatively, the third party may automatically select one of the insurance responses and return an acceptance message. With either method the selected insurance entity transfers a payment to the third party as a fee. The payment may be an electronic transfer from computer 28 to computer 18.

The third party computer may provide a list of insurance entities that can be selected by the buyer. The request is then only transmitted to the selected insurance entities. Alternatively, the request may only be transmitted to insurance entities approved by the third party. As yet another alternative, the request may be transmitted to all insurance entities in an open bidding process.

In block 232 the third party computer can generate and transmit a request for warranty of the goods, to the warranty computers. The data can be mapped and converted into the appropriate party specified field names created by each individual warranty entity. The warranty computers can generate and transmit a response in block 234.

The responses can then be converted and forwarded to the buyer computer in block 236. The buyer may then select one of the warranty responses and return an acceptance in block 238 that is forwarded to the selected warranty computer. Alternatively, the third party may automatically select one of the warranty responses and return an acceptance message. With either method the selected warranty entity transfers a payment to the third party as a fee. The payment may be an electronic transfer from computer 30 to computer 18.

The third party computer may provide a list of warranty entities that can be selected by the buyer. The request is then only transmitted to the selected warranty entities. Alternatively, the request may only be transmitted to warranty entities approved by the third party. As yet another alternative, the request may be transmitted to all warranty entities in an open bidding process.

In block 240 the third party computer can generate and transmit a request for financing to obtain the goods, to the finance computers. The data can be mapped and converted into the appropriate party specified field names created by each individual finance entity. The finance computers can generate and transmit a response in block 242.

The responses can then be converted and forwarded to the buyer computer in block 244. The buyer may then select one of the finance entity responses and return an acceptance in block 246. Alternatively, the third party may automatically select one of the finance entity responses and return an acceptance message. With either method the selected finance entity transfers a payment to the third party as a fee. The payment may be an electronic transfer from computer 32 to computer 18.

The third party computer may provide a list of finance entities that can be selected by the buyer. The request is then only transmitted to the selected finance entity. Alternatively, the request may only be transmitted to finance entities approved by the third party. As yet another alternative, the request may be transmitted to all finance entities in an open bidding process.

The system and method allows for an on-line purchase of goods while allowing the buyer to select the means and cost of transportation, insurance, warranty and financing of the goods. This may result in a lower cost to the buyer. To reduce delays in the system, the third party may create pre-existing relationships with the transportation, insurance, warranty and finance entities.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for transacting business over an electronic communication network, comprising:
transmitting a request to initiate a business transaction over an electronic communication network from a buyer computer, said request being received by a third party computer;
transmitting a response to the request over the electronic communication network from a seller computer, said response being received by the third party computer;
transmitting from the third party computer, a request to secure transportation of goods associated with the request to initiate the business transaction over the electronic communication network, the request to transport goods being received by a transportation computer; and, transmitting from the transportation computer a response to the request to secure transportation of the goods over the electronic communication network, the response being received by the third party computer.

2. The method of claim 1, transmitting an acceptance regarding the transportation of the goods over the electronic communication network, the acceptance being received by the transportation computer.

3. The method of claim 1, transferring a payment from the transportation computer to the third party computer.

4. The method of claim 1, transmitting a request to secure insurance on the goods, the request to insure goods being received by an insurance computer, and transmitting a response to the request to secure insurance of the goods, the response being received by the third party computer.

5. The method of claim 1, transmitting a request to secure financing for the goods, the request to finance goods being received by a finance computer, and transmitting a response to the request to secure financing of the goods, the response being received by the third party computer.

6. The method of claim 1, transmitting a request to secure a warranty on the goods, the request to warrant goods being received by a warranty computer, and transmitting a response to the request to secure a warranty on the goods over the electronic communication network, the response being received by the third party computer.

7. The method of claim 1, wherein the request to secure transportation of the goods is received by a plurality of transportation computers, and the response to the request is transmitted by a plurality of transportation computers, the third party computer transmits an acceptance of the response to one of the transportation computers.

8. The method of claim 2, wherein the third party computer generates the acceptance.

9. The method of claim 1, wherein the request and response are transmitted in TCP/IP format.

10. A system for transacting business over an electronic communication network, comprising:
an electronic communication network;
a buyer computer that transmits a request to initiate a business transaction over said electronic communication network;
a seller computer that transmits a response to the request to initiate a business transaction over said electronic communication network;
a third party computer that receives the request and the response to initiate a business transaction, said third party computer transmitting over said electronic communication network a request to secure transportation of goods associated with the request to initiate the business transaction; and,
a transportation computer that transmits over said electronic communication network a response to the request to secure transportation of the goods, the response being received by said third party computer.

11. The system of claim 10, wherein said third party computer transmits an acceptance regarding the transportation of the goods, the acceptance being received by said transportation computer.

12. The system of claim 10, wherein said transportation computer transfers a payment to said third party computer.

13. The system of claim 10, further comprising an insurance computer that responds to a request from said third party computer to secure insurance on the goods.

14. The system of claim 10, further comprising a finance computer that responds to a request from said third party computer to secure financing for the goods.

15. The system of claim 10, further comprising a warranty computer that responds to a request from said third party compute to secure a warranty on the goods.

16. The system of claim 10, further comprising a plurality of transportation computers that respond to the request for transportation of the goods, said third party computer transmits an acceptance of the response to one of the transportation computers.

17. The system of claim 11, wherein said third party computer generates the acceptance.

18. The system of claim 10, wherein the requests and responses are transmitted in TCP/IP format.

19. A computer for transacting business over an electronic communication network, comprising:
a memory device;
a communication port; and,
a processor that is coupled to said memory device, and said communication port, said processor receives a request to initiate a business transaction over an electronic communication network from a buyer computer, and a response to the request from a seller computer, said processor generates a request to secure transportation of goods associated with the request and the response to initiate the business transaction over the electronic communication network, and receives a response to the request to secure transportation of the goods over the electronic communication network.

20. The computer of claim 19, wherein said processor generates an acceptance regarding the transportation of the goods over the electronic communication network.

21. The computer of claim 19, wherein said processor receives a payment.

22. The computer of claim 19, wherein said processor generates a request to secure insurance on the transportation of goods, and receives a response to the request to secure the insurance.

23. The computer of claim 19, wherein said processor generates a request to secure financing for the goods, and receives a response to the request to secure financing.

24. The computer of claim 19, wherein said processor generates a request to secure a warranty on the goods, and receives a response to the request to secure the warranty.

25. The computer of claim 19, wherein said processor receives responses to the request for transportation from a plurality of transportation computers, and generates an acceptance of the response to one of the transportation computers.

26. The computer of claim 19, wherein said processor generates a list of transportation entities.

27. The computer of claim 19, wherein said communication port transmits the request and the responses in TCP/IP format.

28. A computer program storage medium that can cause a computer to transact business over an electronic communication network, comprising:
a computer readable storage medium that contains a computer program which causes the computer to receive a request to initiate a business transaction over an electronic communication network from a buyer computer, and a response to the request from a seller computer, generate a request to secure transportation of goods associated with the request and the response to initiate the business transaction over the electronic communication network, and receive a response to the request to secure transportation of the goods over the electronic communication network.

29. The storage medium of claim 28, wherein said computer program causes the computer to transmit a confirmation regarding the transportation of the goods over the electronic communication network.

30. The storage medium of claim 28, wherein said computer program causes the computer to receive a payment.

31. The storage medium of claim 28, wherein said computer program causes the computer to generate a request to secure insurance on the goods, and receive a response to the request to secure the insurance.

32. The storage medium of claim 28, wherein said computer program causes the computer to generate a request to secure financing for the goods, and receive a response to the request to secure the financing.

33. The storage medium of claim 28, wherein said computer program causes the computer to generate a request to secure a warranty on the goods, and receive a response to the request to secure the warranty.

34. The storage medium of claim 28, wherein said computer program causes the computer to receive responses to secure transportation of the goods associated with the request to initiate the business transaction from a plurality of transportation computers.

35. The storage medium of claim 28, wherein the computer program causes the computer to generate a list of transportation entities.

36. The storage medium of claim 28, wherein the computer program causes the computer to generate the request and receive the response in TCP/IP format.

37. A method for transacting business over an electronic communication network, comprising:
transmitting a request to initiate a business transaction over an electronic communication network from a buyer computer, said request being received by a third party computer;
transmitting a response to the request over the electronic communication network from a seller computer, said response being received by the third party computer;
transmitting a request to secure insurance of goods associated with the request to initiate the business transaction over the electronic communication network, the request to insure goods being received by an insurance computer; and,
transmitting a response to the request to secure insurance of the goods over the electronic communication network, the response being received by the third party computer.

38. The method of claim 37, transmitting an acceptance regarding the insurance of the goods over the electronic communication network, the confirmation being received by the insurance computer.

39. The method of claim 37, transferring a payment from the insurance computer to the third party computer.

40. The method of claim 37, transmitting a request to secure financing for the goods, the request to finance goods being received by a finance computer, and transmitting a response to the request to secure the financing, the response being received by the third party computer.

41. The method of claim 37, transmitting a request to secure a warranty on the goods, the request to warrant goods being received by a warranty computer, and transmitting a response to the request to secure the warranty, the response being received by the third party computer.

42. The method of claim 37, wherein the request to secure insurance of the goods associated with the request to initiate the business transaction is received by a plurality of insurance computers, and the response to the request is transmitted by a plurality of insurance computers, the third party computer transmits an acceptance of the response to one of the insurance computers.

43. The method of claim 38, wherein the third party computer generates the acceptance.

44. The method of claim 37, wherein the request and response are transmitted in TCP/IP format.

45. A system for transacting business over an electronic communication network, comprising:
an electronic communication network;
a buyer computer that transmits a request to initiate a business transaction over said electronic communication network;
a seller computer that transmits a response to the request to initiate a business transaction over said electronic communication network;
a third party computer that receives the request and the response to initiate a business transaction, said third party computer transmitting over said electronic communication network a request to secure insurance of goods associated with the request to initiate the business transaction; and,
an insurance computer that transmits over said electronic communication network a response to the request to secure insurance of the goods, the response being received by said third party computer.

46. The system of claim 45, wherein said third party computer transmits an acceptance regarding the transportation of the goods over said electronic communication network, the acceptance being received by said insurance computer.

47. The system of claim 45, wherein said insurance computer transfers a payment to said third party computer.

48. The system of claim 45, further comprising a finance computer that responds to a request from said third party computer to secure financing for the goods.

49. The system of claim 45, further comprising a warranty computer that responds to a request from said third party compute to secure a warranty on the goods.

50. The system of claim 45, further comprising a plurality of insurance computers that respond to the request for insurance of the goods associated with the request to initiate a business transaction, said third party computer transmits an acceptance of the response to one of the insurance computers.

51. The system of claim 46, wherein said third party computer generates the acceptance.

52. The system of claim 45, wherein the requests and responses are transmitted in TCP/IP format.

53. A computer for transacting business over an electronic communication network, comprising:
a memory device;
a communication port; and,
a processor that is coupled to said memory device and said communication port, said processor receives a request to initiate a business transaction over an electronic communication network from a buyer computer, and a response to the request from a seller computer, said processor generates a request to secure insurance of goods associated with the request and the response to initiate the business transaction over the electronic communication network, and receives a response to the request to secure insurance of the goods over the electronic communication network.

54. The computer of claim 53, wherein said processor generates an acceptance regarding the insurance of the goods over the electronic communication network.

55. The computer of claim 53, wherein said processor receives a payment.

56. The computer of claim 53, wherein said processor generates a request to secure financing for the goods, and receives a response to the request to secure the financing.

57. The computer of claim 53, wherein said processor generates a request to secure a warranty on the goods, and receives a response to the request to secure the warranty.

58. The computer of claim 53, wherein said processor receives responses to the request for insurance from a plurality of insurance computers, and generates an acceptance of the response to one of the insurance computers.

59. The computer of claim 53, wherein said processor generates a list of insurance entities.

60. The computer of claim 53, wherein said communication port transmits the request and the responses in TCP/IP format.

61. A computer program storage medium that can cause a computer to transact business over an electronic communication network, comprising:
a computer readable storage medium that contains a computer program which causes the computer to receive a request to initiate a business transaction over an electronic communication network from a buyer computer, and a response to the request from a seller computer, generate a request to secure insurance of goods associated with the request and the response to initiate the business transaction over the electronic communication network, and receive a response to the request to secure insurance of the goods over the electronic communication network.

62. The storage medium of claim 61, wherein said computer program causes the computer to transmit a confirmation regarding the insurance of the goods over the electronic communication network.

63. The storage medium of claim 61, wherein said computer program causes the computer to receive a payment.

64. The storage medium of claim 61, wherein said computer program causes the computer to generate a request to secure financing for the goods, and receive a response to the request to secure the financing.

65. The storage medium of claim 61, wherein said computer program causes the computer to generate a request to secure a warranty on the goods, and receive a response to the request to secure the warranty.

66. The storage medium of claim 61, wherein said computer program causes the computer to receive responses to secure insurance of the goods associated with the request to initiate the business transaction from a plurality of insurance computers.

67. The storage medium of claim 61, wherein the computer program causes the computer to generate a list of transportation entities.

68. The storage medium of claim 61, wherein the computer program causes the computer to generate the request and receive the response in TCP/IP format.

69. A method for transacting business over an electronic communication network, comprising:
transmitting a request to initiate a business transaction over an electronic communication network from a buyer computer, said request being received by a third party computer;
transmitting a response to the request over the electronic communication network from a seller computer, said response being received by the third party computer;
transmitting from the third party computer a request to secure a warranty of the goods associated with the request to initiate the business transaction over the electronic communication network, the request to transport goods being received by a warranty computer; and,
transmitting from the warranty computer a response to the request to secure the warranty of the goods over the electronic communication network, the response being received by the third party computer.

70. The method of claim 69, transmitting an acceptance regarding the warranty of the goods over the electronic communication network, the acceptance being received by the warranty computer.

71. The method of claim 69, transferring a payment from the warranty computer to the third party computer.

72. The method of claim 69, transmitting a request to secure financing for the goods, the request to warrant goods being received by a finance computer, and transmitting a response to the request to secure the financing.

73. The method of claim 69, wherein the request to secure warranty of the goods associated with the request to initiate the business transaction is received by a plurality of warranty computers, and the response to the request is transmitted by a plurality of warranty computers, the third party computer transmits an acceptance of the response to one of the warranty computers.

74. The method of claim 70, wherein the third party computer generates the acceptance.

75. The method of claim 69, wherein the request and response are transmitted in TCP/IP format.

76. A system for transacting business over an electronic communication network, comprising:
an electronic communication network;
a buyer computer that transmits a request to initiate a business transaction over said electronic communication network;
a seller computer that transmits a response to the request to initiate a business transaction over said electronic communication network;
a third party computer that receives the request and the response to initiate a business transaction, said third party computer transmitting over said electronic communication network a request to secure a warranty of the goods associated with the request to initiate the business transaction; and,
a warranty computer that transmits over said electronic communication network a response to the request to secure the warranty of the goods, the response being received by said third party computer.

77. The system of claim 76, wherein said third party computer transmits an acceptance regarding the warranty of the goods over said electronic communication network, the acceptance being received by said warranty computer.

78. The system of claim 76, wherein said warranty computer transfers a payment to said third party computer.

79. The system of claim 76, further comprising a finance computer that responds to a request from said third party computer to secure financing for the goods.

80. The system of claim 76, further comprising a plurality of warranty computers that respond to the request for warranty of the goods associated with the request to initiate a business transaction, said third party computer transmits an acceptance of the response to one of the warranty computers.

81. The system of claim 76, wherein said third party computer generates the acceptance.

82. The system of claim 75, wherein the requests and responses are transmitted in TCP/IP format.

83. A computer for transacting business over an electronic communication network, comprising:
a memory device;
a communication port; and,
a processor that is coupled to said memory device and said communication port, said processor receives a request to initiate a business transaction over an electronic communication network from a buyer computer, and a response to the request from a seller computer, said processor generates a request to secure a warranty of the goods associated with the request and the response to initiate the business transaction over the electronic communication network, and receives a response to the request to secure warranty of the goods over the electronic communication network.

84. The computer of claim 83, wherein said processor generates an acceptance regarding the warranty of the goods over the electronic communication network.

85. The computer of claim 83, wherein said processor receives a payment.

86. The computer of claim 83, wherein said processor generates a request to secure financing for the goods, and receives a response to the request to secure the financing.

87. The computer of claim 83, wherein said processor receives responses to the request for warranty from a plurality of warranty computers, and generates an acceptance of the response to one of the warranty computers.

88. The computer of claim 83, wherein said processor generates a list of warranty companies.

89. The computer of claim 83, wherein said output port transmits the request and the responses in TCP/IP format.

90. A computer program storage medium that can cause a computer to transact business over an electronic communication network, comprising:
a computer readable storage medium that contains a computer program which causes the computer to receive a request to initiate a business transaction over an electronic communication network from a buyer computer, and a response to the request from a seller computer, generate a request to secure a warranty of the goods associated with the request and the response to initiate the business transaction over the electronic communication network, and receive a response to the request to secure the warranty of the goods over the electronic communication network.

91. The storage medium of claim 90, wherein said computer program causes the computer to transmit an acceptance regarding the warranty of the goods over the electronic communication network.

92. The storage medium of claim 90, wherein said computer program causes the computer to receive a payment.

93. The storage medium of claim 90, wherein said computer program causes the computer to generate a request to secure financing for the goods, and receive a response to the request to secure the financing.

94. The storage medium of claim 90, wherein said computer program causes the computer to receive responses to secure the warranty of the goods associated with the request to initiate the business transaction from a plurality of warranty computers.

95. The storage medium of claim 90, wherein the computer program causes the computer to generate a list of warranty entities.

96. The storage medium of claim 28, wherein the computer program causes the computer to generate the request and receive the response in TCP/IP format.

97. A method for mapping data to fields of a graphical user interface used to transact business over an electronic communication network, comprising:
generating a party graphical user interface that correlates a buyer specified data field to a predefined data field at a party computer, said buyer graphical user interface used to conduct a business transaction over the electronic communication network; and,
mapping only data of the predefined data field of a data file to the party specified data field.

98. The method of claim 97, wherein the party graphical user interface selects a data translation technique that is stored in memory.

99. The method of claim 97, wherein the translation technique includes a look up table.

100. A system for mapping data to fields of a graphical user interface used to transact business over an electronic communication network, comprising:
an electronic communication network;
a party computer that generates a party graphical user interface that correlates a buyer specified data field with a predefined field that is used to conduct a business transaction over said electronic communication network;
a third party computer that maps only data of the predefined field of a data file to the party specified data field.

101. The system of claim 100, wherein said party graphical interface includes a translation field.

102. A computer for mapping data to fields of a graphical user interface used to transact business over an electronic communication network, comprising:
a memory device;
a communication port;
a processor that maps only data of a predefined data field of a data file to a party specified data field generated through a party graphical user interface.

103. The computer of claim 102, wherein said processor translates data between the predefined data field and the party specified data field.

104. A computer program storage medium that can cause a computer to map data to fields of a graphical user interface used to transact business over an electronic communication network, comprising:
a computer readable storage medium that contains a computer program which causes the computer to map only data of a predefined data field of a data file to a party specified data field generated through a party graphical user interface.

105. The storage medium of claim 104, wherein said computer program causes the computer to translate data between the predefined data field and the party specified data field.
